(19) United States
(12) Patent Application Publication
(10) Pub. No.: US 2017/0292312 A1
(43) Pub. Date: Oct. 12, 2017

(54) WINDOW REGULATOR FOR VEHICLE

(71) Applicant: SHIROKI CORPORATION, Fujisawa-shi (JP)

(72) Inventors: Kazuya YOKOYAMA, Fujisawa-shi (JP); Kenji YAMAMOTO, Fujisawa-shi (JP); Yuta KAJIMOTO, Fujisawa-shi (JP)

(73) Assignee: SHIROKI CORPORATION, Fujisawa-shi (JP)

(21) Appl. No.: 15/466,580

(22) Filed: Mar. 22, 2017

(30) Foreign Application Priority Data
Apr. 12, 2016 (JP) 2016-079671

(51) Int. Cl. E05F 15/689; B60J 1/17; E05D 15/16

(52) U.S. Cl. CPC E05F 15/689; E05D 15/165; B60J 1/17; E05Y 2900/55

(57) ABSTRACT

A window regulator for a vehicle includes a guide rail, and a slider base ascendably and descendably supported by the guide rail, to which a window glass is fixed, and ascends and descends the slider base with respect to the guide rail. The guide rail includes a vehicle width-direction wall extending along a vehicle width direction, and the slider base includes a restricting wall which restricts movement of the slider base along a vehicle longitudinal direction, and an anti-rattle portion positioned toward a side of the vehicle width-direction wall with respect to the restricting wall in the vehicle longitudinal direction, the anti-rattle portion restricting movement of the slider base in the vehicle longitudinal direction.

### BACKGROUND OF THE INVENTION

### 1. Field of the Invention

The present invention relates to a window regulator for a vehicle.

### 2. Description of Related Art

Window regulators for vehicles include, in their fundamental structure, a guide rail extending in a longitudinal direction, a slider base ascendably/descendably supported by the guide rail, to which a window glass is fixed, and a wire drive mechanism (for example, a wire, a drum, a motor, a pulley, and the like) which ascends/descends the slider base with respect to the guide rail.

When attaching such a window regulator to a vehicle door panel, a guide rail is fixed to the vehicle door panel and a slider base is ascended/descended with respect to the guide rail via a wire drive mechanism to place it at a predetermined glass mounting position. Then, a window glass is fixated to the slider base.

### Patent Literature 1

Japanese Unexamined Patent Publication No. 2013-217080

However, the slider base has a clearance with respect to the guide rail along its width direction (the longitudinal direction (forward/rearward direction) of the vehicle) so that the slider base is movable or rotatable (pivotable) in the width direction (the longitudinal direction of the vehicle) with respect to the guide rail. This structure entails a drawback that the slider base moves or rotates (pivots) along the width direction (the longitudinal direction of the vehicle) when fixing the window glass to the slider base, making it difficult to position the slider base and the window glass.

In recent years, the so-called flush surface structure is known, in which a vehicle door panel and a window glass are formed in a flush flat surface by eliminating the unevenness and gaps therebetween, to suppress the air resistance and prevent wind noise while traveling, as well as improving the appearance of the structure. However, with the flush surface structure, the clearance of the slider base and the guide rail along the width direction (the longitudinal direction of the vehicle) is (unavoidably) enlarged. Consequently, when fixing the window glass to the slider base, the slider base may easily move (rotate or pivot) in the width direction (the longitudinal direction of the vehicle) to make it even more difficult to position the slider base and the window glass. Thus, the above-mentioned drawback is exhibited even more prominently.

### SUMMARY OF THE INVENTION

The present invention has been proposed in consideration of the above-described problem and an object thereof is to provide a window regulator for a vehicle, which can prevent a slider base from moving (rotating or pivoting) along its width direction (the longitudinal direction of the vehicle) when mounting the window glass to a slider base, thereby making it possible to easily position the slider base and window glass.

According to an aspect of the present invention, a window regulator for a vehicle is provided, including a guide rail; a slider base ascendably and descendably supported by the guide rail, to which a window glass is fixed; and a wire drive mechanism which ascends and descends the slider base with respect to the guide rail. The guide rail includes a vehicle width-direction wall extending along a vehicle width direction. The slider base includes a restricting wall which restricts movement of the slider base in a vehicle longitudinal direction, and an anti-rattle portion positioned toward a side of the vehicle width-direction wall with respect to the restricting wall in the vehicle longitudinal direction, the anti-rattle portion restricting movement of the slider base in the vehicle longitudinal direction.

It is desirable for the anti-rattle portion to include front and rear anti-rattle portions provided at different positions with respect to the vehicle longitudinal direction, the front and rear anti-rattle portions respectively abutting against front and rear sides of the vehicle width-direction wall at all times. The slider base includes a pair of glass mounting oblong holes formed in the slider base at front and rear sides of the vehicle width-direction wall with respect to the vehicle longitudinal direction, each of the glass mounting oblong holes being elongated in the vehicle longitudinal direction.

It is desirable for one of the front and rear anti-rattle portions to be a pair of anti-rattle portions configured to be separated from each other with respect to an ascending and descending direction, and for the other of the front and rear anti-rattle portions to be an anti-rattle portion provided at a middle position between the pair of anti-rattle portions with respect to the ascending and descending direction.

It is desirable for the restricting wall to include a pair of restricting walls provided separated from each other with respect to an ascending and descending direction, and for the anti-rattle portion to be provided between the pair of restricting walls.

According to the present invention, a window regulator for a vehicle is achieved, in which, when a window glass is fixed to a slider base, the slider base is prevented from moving in a width direction (a longitudinal direction of the vehicle) (or rotating or pivoting), whereby positioning of a slider base and a window glass can be easily carried out.

The present disclosure relates to subject matter contained in Japanese Patent Application No. 2016-079671 (filed on Apr. 12, 2016) which are expressly incorporated herein by reference in their entireties.

### BRIEF DESCRIPTION OF THE DRAWINGS

FIG. 1 is a front view of a window regulator according to the illustrated embodiment as viewed from outside the vehicle.

FIG. 2 is an enlarged view of section II in FIG. 1.

FIG. 3 is a cross-section taken along the line III-III in FIG. 2.

FIG. 4 is a cross-section taken along the line IV-IV in FIG. 2.

FIG. 5 is a right-side view of that shown, in FIG. 2 (as viewed from a rear side), excluding the guide rail.

FIG. 6 is a cross-section taken along the line VI-VI in FIG. 5.

FIG. 7 is a perspective view of a single body of a resin block of the slider base.

FIG. 8 is a perspective view of the slider base.

### DESCRIPTION OF THE EMBODIMENTS

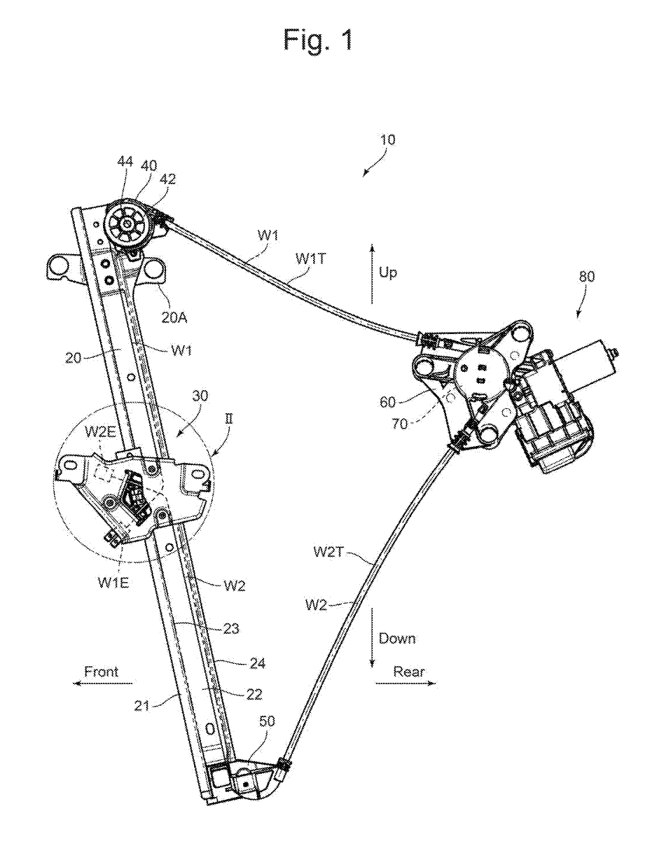

An embodiment of a window regulator 10 of the present invention will be described hereinbelow. As shown in FIG. 1, the window regulator 10 includes an elongated guide rail 20. The guide rail 20 is attached to an inner side of a door panel (not shown) of a vehicle via brackets 20A (only an upper bracket 20A is shown in FIG. 1) provided at different positions along a longitudinal direction thereof. The guide rail 20 is disposed so that the longitudinal direction thereof extends substantially in the height direction of the vehicle while being mounted to the door panel of the vehicle.

The window regulator 10 includes a slider base (glass carrier) 30 ascendably/descendably supported by the guide rail 20 and supporting a window glass (not shown). Wire ends W1E and W2E of a pair of respective drive wires W1 and W2 are connected to the slider base 30.

A pulley bracket 40 is fixed near a longitudinal upper end of the guide rail 20. A guide pulley 42 is rotatably supported on the pulley bracket 40 via a pulley support shaft 44. The drive wire W1 extends upwards from the slider base 30 along the guide rail 20 and is supported by a wire guide groove formed in a circumferential surface of the guide pulley 42. As the drive wire W1 is advanced and retracted, the guide pulley 42 rotates around the pulley support shaft 44.

A wire guide member 50 is formed near a longitudinal lower end of the guide rail 20. The drive wire W2 extends downwards from the slider base 30 along the guide rail 20 and is guided by a wire guide member 50. The wire guide member 50 is fixed to the guide rail 20, and the drive wire W2 is supported by the wire guide groove formed in the wire guide member 50 so as to advance and retract therealong.

The drive wire W1 extending out from the guide pulley 42 is inserted through a tubular outer tube W1T and is wound around a driving drum 70, provided in a drum housing 60 to which the outer tube W1T is connected. The drive wire W2 projecting out from the wire guide member 50 is inserted through a tubular outer tube W2T and is wound around the driving drum 70, provided in the drum housing 60 to which the outer tube W2T is connected.

A motor unit 80 is attached to the drum housing 60. The motor unit 80 includes a drive motor to rotate the driving drum 70 and a gear box (not shown).

One end of the outer tube W1T is connected to the pulley bracket 40 and the other end of the outer tube W1T is connected to the drum housing 60, and the drive wire W1 can be advanced and retracted within the outer tube W1T. One end of the outer tube W2T is connected to the wire guide member 50 and the other end is connected to the drum housing 60, and the drive wire W2 can be advanced and retracted within the outer tube W2T.

The drum housing 60 is fixed to the door panel (not shown) of the vehicle. When the driving drum 70 rotates forward/backward by the driving force of the motor in the motor unit 80, one of the drive wires W1 and W2 increases the amount of winding to the driving drum 70, and the other one is unreeled from the driving drum 70. Thus, the drive wire W1 is pulled, whereas the drive wire W2 is slackened, and due to the relationship therebetween, the slider base 30 moves along the guide rail 20. The window glass (not shown) moves up and down (ascends/descends) in accordance with the movement of the slider base 30.

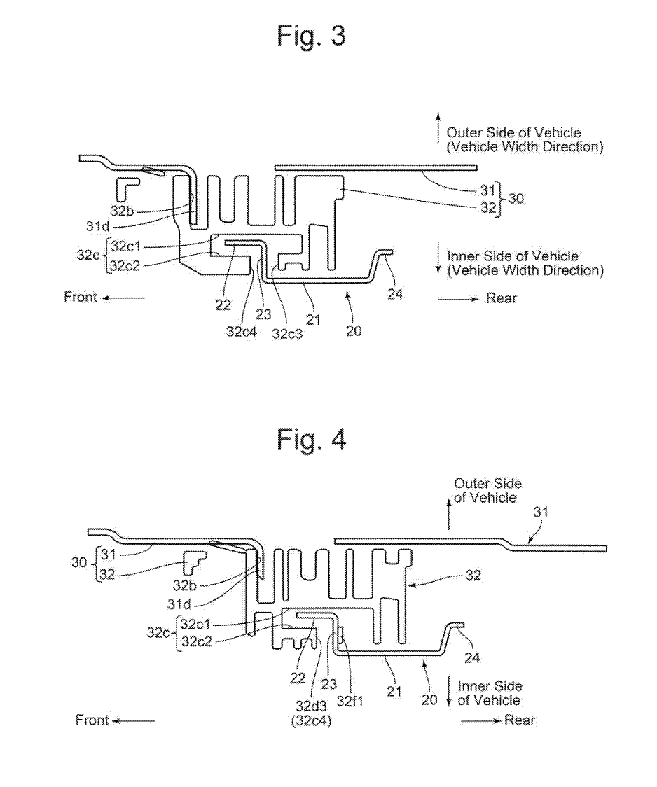

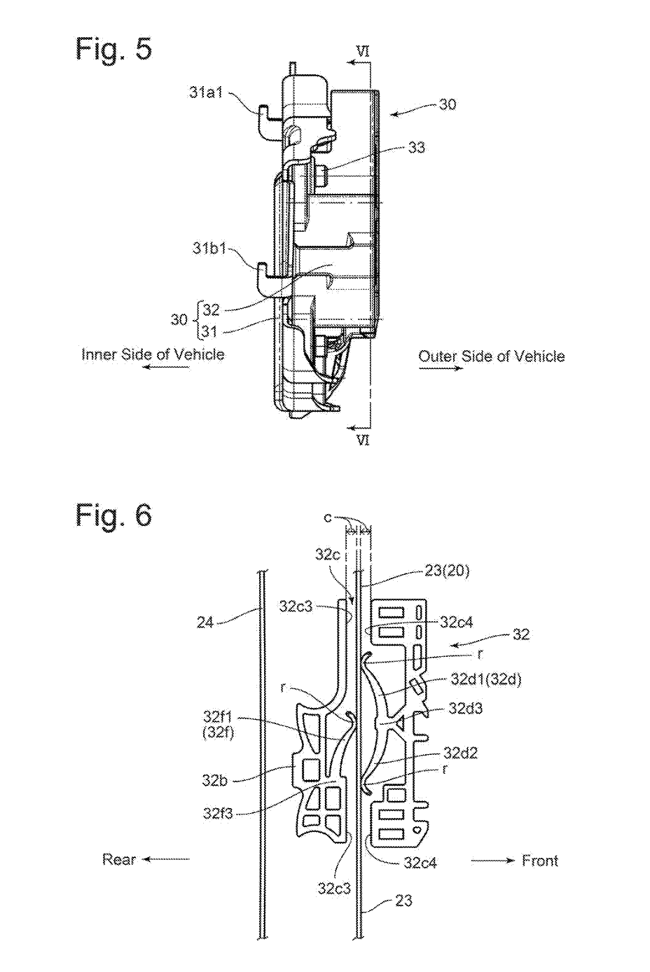

The structures of the guide rail 20 and the slider base 30 in the window regulator 10 having the above-described basic structure will be described in detail. The guide rail 20 has a hat-like cross section, as shown in FIG. 3 and FIG. 4, including inner and outer forwardly/rearwardly extending walls 21 and 22, a vehicle width extending wall 23 which connects the forwardly/rearwardly extending walls 21 and 22 together, and a book-like wall 24 extending toward the vehicle outside from an end of the forwardly/rearwardly extending wall 21, which is on an opposite side of the forwardly/rearwardly extending wall 21 with respect to the vehicle width extending wall 23. The forwardly/rearwardly extending wall 22 constitutes a rail portion which restricts the position (movement) of the guide rail 20 in the vehicle width direction. It should be noted that although each of forwardly/rearwardly extending walls 21 and 22, the vehicle width extending wall 23 and the hook-like wall 24 have been termed (named) with respect to the cross section taken through (in the longitudinal direction of the vehicle) the guide rail 20, these walls also constitute longitudinal wall portions, respectively, that extend in the longitudinal direction (in the approximate vertical direction) of the guide rail 20.

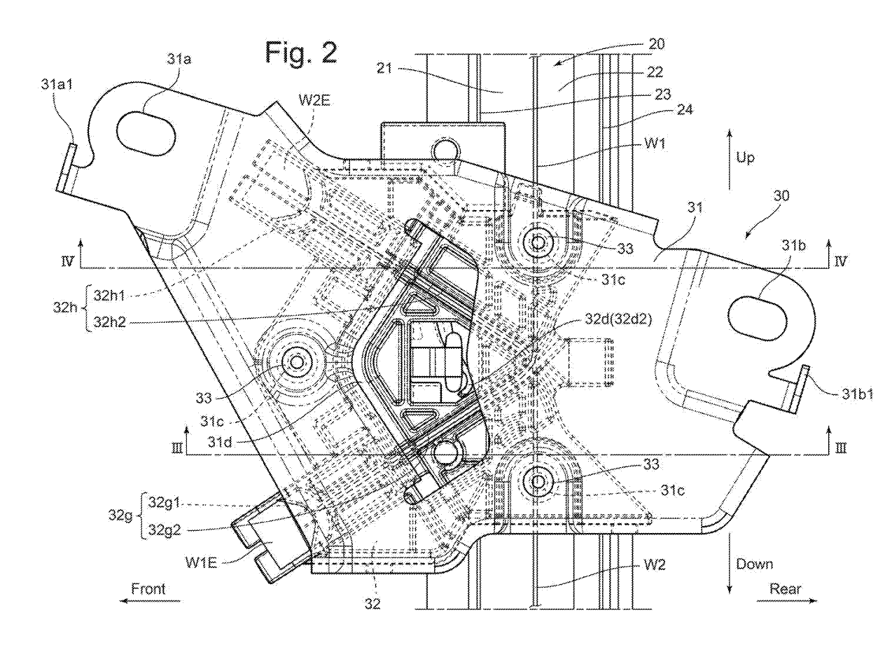

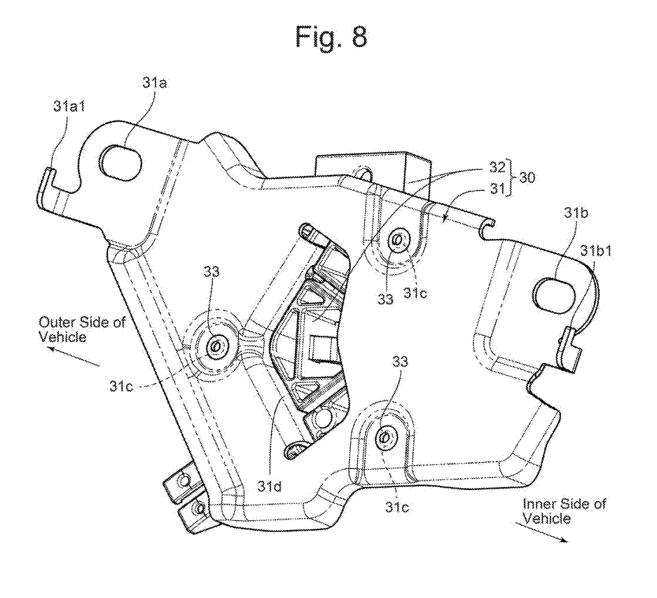

The slider base 30 is an integral member configured of a metal plate 31 located on an outer side of the vehicle, formed by pressing a metal material, and a resin block 32 located on an inner side of the vehicle, formed by molding a resin material. As shown in FIG. 2 and FIG. 8, the metal plate 31 comprises two oblong holes (slots) 31a and 31b for mounting the glass, three rivet mounting holes 31c, and a joint bent edge 31d. The glass-mounting oblong holes 31a and 31b are oblong holes elongated along the longitudinal direction of the vehicle, which are formed in a front end portion and a rear end portion of the vehicle with respect to the longitudinal direction.

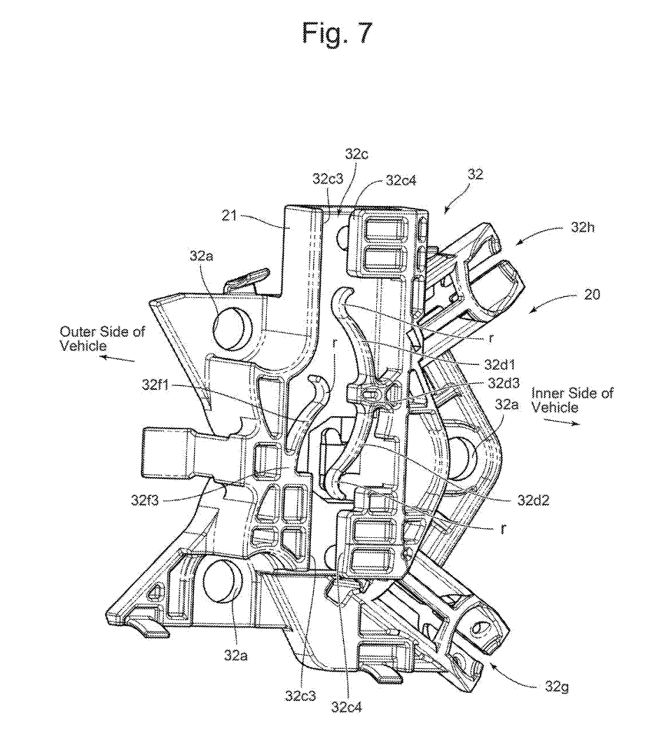

FIG. 2 (FIG. 8) illustrates the shape of the resin block 32 as viewed from the outer side of the vehicle, and FIG. 7 illustrates that viewed from the inner side. As shown in these drawings, the resin block 32 includes three joining holes 32a corresponding to the three rivet mounting holes 31c of the metal plate 31. Rivets 33 inserted into the joining holes 32a, respectively, are also inserted to the respective rivet mounting holes 31c, to thereby join (rivet) the resin block 32 to the metal plate 31 by caulking (clinching). When the metal plate 31 and the resin block 32 are joined together, the joining bent edge 31d of the metal plate 31 abuts against an abutment edge 32b (FIGS. 3 and 4) of the resin block 32 to prevent both members from displacing relative to each other. The window glass (not shown) is mounted onto the metal plate 31 (slider base 30) via the glass mounting oblong holes 31a and 31b of the slider base 30, which is an integral member configured of the metal plate 31 and the resin block 32. Reference designators 31a1 and 31b1 respectively denote hooks formed to be integrated with the metal plate 31, so as to hold the lower end portion of the window glass when the window glass (not shown) is mounted on the slider base 30. Note that the slider base, to which the window glass is mounted, includes a type in which the window glass is fixed via a glass holder attached to the lower end of the window glass.

The resin block 32 includes an insertion groove 32c formed along a vertical direction, in which the forwardly/rearwardly extending wall 22 and the vehicle width extending wall 23 of the guide rail 20 are inserted. The insertion groove 32c includes vehicle width direction restricting walls 32c1 and 32c2 (FIGS. 3, 4, 6 and 7) which face the vehicle inner and outer sides of the forwardly/rearwardly extending wall 22. The insertion groove 32c also includes respective pairs of forward/rearward direction restricting walls 32c3 and 32c4 (FIGS. 3, 4 and 7) which face vehicle forward and rearward sides of the vehicle width direction wall 23 so as to oppose each other. When the slider base 30 (resin block 32) moves in the vehicle width direction, the vehicle width direction restricting walls 32c1 and 32c2 of the insertion groove 32c abut against the forwardly/rearwardly extending wall 22 so as to restrict the moving range along the vehicle width direction.

Similarly, when the slider base 30 (the resin block 32) moves in the vehicle longitudinal (forward/rearward) direction with respect to the guide rail 20, the forward/rearward direction restricting walls 32c3 and 32c4 of the resin block 32 abut against the vehicle width direction wall 23 so as to restrict the moving range in the vehicle longitudinal (forward/rearward) direction. However, when the vehicle width direction wall 23 is located at a middle position between the forward/rearward direction restricting walls 32c3 and 32c4, a clearance “c” between the vehicle width direction wall 23 and the forward/rearward direction restriction wall 32c3 and a clearance “c” between the vehicle width direction wall 23 and the forward/rearward direction restricting walls 32c4 (FIG. 6) are set to be wide (relatively large). In this embodiment, plate-like resin springs (front and rear anti-rattle portions) 32d and 32f are formed on the resin block 32 to be situated respectively on the front and rear sides of the vehicle width direction wall 23, thus suppressing rattling of the slider base 30 (resin block 32) and the vehicle width direction wall 23 (guide rail 20) in the vehicle longitudinal direction, which may occur when the clearances “c” are wide, as much as possible. The resin spring 32d includes a pair of spring urging portions (anti-rattle portions) 32d1 and 32d2 abutting at two locations along an upper-and-lower direction on the front side of the vehicle width direction wall 23 with respect to the vehicle longitudinal direction. The resin spring 32f includes a single spring urging portion 32f1 abutting at a middle location, with respect to an upward/downward direction, between the spring urging portions 32d1 and 32d2 on the rear side of the vehicle width direction wall 23.

The pair of spring urging portions 32d1 and 32d2 are cantilever springs extending upwards and downwards from the upper and lower sides of a support pardon 32d3, and the spring urging portion 32f1 is a cantilever spring extending upwards from the support portion 32f3. Each of the spring urging portions 32d1 and 32d2 and the spring urging portion 32f1 are parabolic in shape, as viewed from the vehicle width direction, in which the radius of curvature and the thickness (in the forward/rearward direction) decreases from the support portions 32d3 and 32f3 toward the respective distal end portions (free ends). Furthermore, a convex portion “r” that faces against (contacts) the vehicle width direction wall 23 is formed at the distal end (free end) of each of the spring urging portions 32d1 and 32d2 and the spring urging portion 32f1.

Accommodation mounts 32g and 32h for accommodating and fixing the drive wires W1 and of W2 are formed on a vehicle outer side surface (the surface in contact with the metal plate 31) of the resin block 32. The accommodation mounts 32g and 32h respectively include wire end engagement portions 32g1 and 32h1, with which respective wire ends W1E and W2E of the drive wires W1 and W2 are engaged, and guiding grooves 32g2 and 32h2 which guide the drive wires W1 and W2 withdrawn from the wire end engagement portion 32g1 and 32h1. A compression springs (not shown) are inserted in between the wire ends W1E and W2E and the wire end engagement portions 32g1 and 32h1, respectively. The drive wires W1 and W2 drawn from the respective wire end engagement portions 32g1 and 32h1 are guided by the guiding grooves 32g2 and 32h2 toward a wire guide member 50 located in a lower portion and a guide pulley 42 located in an upper portion. The drive wire W1 and W2 cross each other as viewed from the vehicle width direction as shown in FIG. 2.

Before the window glass is mounted, the window regulator 10 is held in a neutral state in which the forward/rearward direction restricting walls 32c3 and 32c4 maintain a certain clearance “c” from the vehicle width direction wall 23 with the resin spring 32d and the resin spring 32f abutting against the vehicle width direction wall 23 from the front and rear sides thereof, respectively. Thus, the slider base 30 cannot easily rotate (pivot) in the width direction of the guide rail 20 (the longitudinal direction of the vehicle) when the window glass (not shown) is being mounted onto the slider base 30. Therefore, the slider base 30 and the window glass can be easily positioned. In addition, the glass-mounting oblong holes 31a and 31b are formed at forward and rearward positions, respectively, of the vehicle width direction wall 23 (with respect to the longitudinal direction of the vehicle). With this structure, the window glass cannot easily incline forwardly or rearwardly, thereby facilitating the positioning of the slider base 30 and the window glass.

Since the resin spring 32f is located in the middle portion between the spring urging portions 32d1 and 32d2 with respect to the height (upward/downward) direction, the window regulator 10 can prevent the slider base 30 from inclining forwardly or rearwardly, or from rotating. Furthermore, if the resin block 32 moves to forwardly or rearwardly from a neutral position, with respect to the vehicle width direction wall 23, the urging force of the spring urging portions 32d1 and 32d2 or the spring urging portion 32f1 become stronger as the resin block 32 moves further in distance, and hence, the suppressing force of controlling the movement of the resin block 32 becomes stronger.

The window regulator 10 described above operates in the following manner especially when the slider base 30 (window glass) tries to move forwardly or rearward with respect to the guide rail 20. In other words, when the slider base 30 is about to move forward from the neutral position (FIG. 6) to cause the forward/rearward direction restricting walls 32c3 (32c4) to approach the vehicle width direction wall 23, the resin spring 32f is elastically deformed to apply a resistance (load) against such movement, thereby restricting forward movement of the slider base 30 from the neutral position. Similarly, when the slider base 30 is about to move rearward from the neutral position (FIG. 6) to cause the forward/rearward direction restricting walls 32c4 to approach the vehicle width direction wall 23, the resin spring 31d is elastically deformed to apply a resistance (load) against such movement, thereby restricting rearward movement of the slider base 30 from the neutral position. This advantageous effect can also be exhibited when the moving force of the vehicle in the longitudinal (forward/rearward) direction acts on the window glass, which is created when the vehicle is subjected to sudden acceleration or sudden braking.

The window regulator 10 of the illustrated embodiment is also applicable to a flush door. When applied to a flush door, the positions of the glass and the door frame along the vehicle longitudinal (forward/rearward) direction are predetermined, and therefore play in the longitudinal direction of the vehicle must be absorbed by the guide rail 20 and the slider basis 30. Therefore, the slider base 30 is movably supported with respect to the guide rail 20 in the longitudinal direction of the vehicle. However, if such play exists while attaching the glass to the slider base 30, the positions of the slider base 30 and the glass cannot be determined. Therefore, in the present invention, the anti-rattle portions (resin springs 32d and 32f) are provided on the front and rear sides (with respect to the vehicle width direction wall 23). Accordingly, since the positions of the door frame and the glass are determined, the glass mounting oblong holes 31a and 31b are formed to be elongated in the forward/rearward direction of the vehicle in order to absorb any variations (play) that may occur, e.g., due to manufacturing error.

In the illustrated embodiment, since the pair of forward/rearward direction restricting walls 32c3 are separated from each other along the ascending/descending direction, and the pair of forward/rearward direction restricting walls 32c4 are likewise separated from each other along the ascending/descending direction, the slider base 30 does not easily deform when the slider base 30 restricts its own movement (rotation or pivoting) in the width directions (the longitudinal direction of the vehicle). Further, since the spring urging portion 32f1 is located between the pair of forward/rearward direction restricting walls 32c3, and the spring urging portions 32d1 and 32d2 are located between the pair of forward/backward direction restricting walls 32c4, the spring urging portions 32d1 and 32d2 and the spring urging portion 32f1 can be provided in a narrow space with respect to the forward/rearward direction (vehicle longitudinal direction).

The spring urging portions 32d1 and 32d2 and the spring urging portion 32f1 are cantilever springs, and therefore the movable stroke can be set wide compared to the forward/rearward space accommodating the spring urging portions 32d1, 32d2 and 32f1. Therefore, it is possible to inhibit rattling and maintain accuracy in positioning while having wide clearances for the resin block 32 and the vehicle width direction wall 23 in the forward/rearward direction. Further, the spring urging portions 32d1, 32d2 and 32f1 are formed into parabolic shapes, and with this structure, stress is not concentrated at the joining portions between the spring urging portions 32d1, 32d2 and 32f1 and the respective support portions 32d3 and 32f3, and thus the joining portions are not easily damaged.

In addition, the maximum approaching positions (that is, the amount of maximum deformation) of the spring urging portion 32d1, 32d2 and 32f1 with respect to the vehicle width direction wall 23 is limited (determined) at positions where the forward/rearward direction restricting walls 32c3 and 32c4 abut against the vehicle width direction wall 23.

In the above-described embodiment, the resin springs 32d and 32f are formed at the front and rear sides of the vehicle width direction wall 23, however, only one of the resin springs 32d and 32f may be provided only on a corresponding one of the front and rear sides.

Obvious changes may foe made in the specific embodiments of the present invention described herein, such modifications being within the spirit and scope of the invention claimed. It is indicated that all matter contained herein is illustrative and does not limit the scope of the present invention.

What is claimed is:

1. A window regulator for a vehicle, comprising:
a guide rail;
a slider base ascendably and descendably supported by the guide rail, to which a window glass is fixed; and
a wire drive mechanism which ascends and descends the slider base with respect to the guide rail,
wherein the guide rail includes a vehicle width-direction wall extending along a vehicle width direction, and
wherein the slider base includes a restricting wall which restricts movement of the slider base in a vehicle longitudinal direction, and an anti-rattle portion (32f, 32d) positioned toward a side of the vehicle width-direction wall with respect to the restricting wall in the vehicle longitudinal direction, said anti-rattle portion restricting movement of the slider base in the vehicle longitudinal direction.

2. The window regulator according to claim 1, wherein the anti-rattle portion comprises front and rear anti-rattle portions provided at different positions with respect to the vehicle longitudinal direction, the front and rear anti-rattle portions respectively abutting against front and rear sides of the vehicle width-direction wall at all times, and
wherein the slider base includes a pair of glass mounting oblong holes formed in the slider base at front and rear sides of the vehicle width-direction wall with respect to the vehicle longitudinal direction, each of the glass mounting oblong holes being elongated in the vehicle longitudinal direction.

3. The window regulator according to claim 2, wherein one of the front and rear anti-rattle portions further comprises a pair of anti-rattle portions configured to be separated from each other with respect to an ascending and descending direction, and
wherein the other of the front and rear anti-rattle portions comprises an anti-rattle portion provided at a middle position between the pair of anti-rattle portions with respect to the ascending and descending direction.

4. The window regulator according to claim 1, wherein the restricting wall comprises a pair of restricting walls provided separated from each other with respect to an ascending and descending direction, and
wherein the anti-rattle portion is provided between the pair of restricting walls.
